(19) United States
(12) Patent Application Publication
(10) Pub. No.: US 2025/0021384 A1
(43) Pub. Date: Jan. 16, 2025

(54) STORAGE BANDWIDTH MANAGEMENT

(71) Applicant: INTERNATIONAL BUSINESS MACHINES CORPORATION, ARMONK, NY (US)

(72) Inventors: Karthik Baskaran, San Antonio, TX (US); Tiberiu Suto, Franklin, NY (US); Nadiya Kochura, Bolton, MA (US); Arashad Ahamad, Hyderabad (IN); Hemant Kumar Sivaswamy, Pune (IN)

(21) Appl. No.: 18/352,517

(22) Filed: Jul. 14, 2023

(51) Int. Cl. G06F 9/50

(52) U.S. Cl. CPC G06F 9/5011

(57) ABSTRACT

Described are techniques for bandwidth allocation in container orchestration systems. The techniques include monitoring storage bandwidth designated for one or more storage operations in association with one or more storage volumes attached to a server that hosts containerized applications, where a fixed amount of bandwidth provided to the server is divided between the storage bandwidth available for the one or more storage operations and network bandwidth available for network operations. The techniques further include determining that increasing the storage bandwidth will improve performance of at least one of the one or more storage operations. The techniques further include identifying an amount of the network bandwidth as being available for reallocation to the storage bandwidth, and reallocating the amount of the network bandwidth to the storage bandwidth for use in performing the one or more storage operations.

### BACKGROUND

The present disclosure relates to container orchestration systems, and, more specifically, to bandwidth allocation in container orchestration systems.

Bandwidth allocation to a server (e.g., virtual server instance (VSI) or virtual machine (VM)) in a computing service environment is the process of dividing available bandwidth between the network (network bandwidth) and storage components (storage bandwidth) of the server. The network bandwidth may be used for network traffic that flows to and from the server, including web traffic, database traffic, and file sharing. The storage bandwidth may be used for network traffic that flows to and from the server's storage volumes, such as boot disks and data disks.

### SUMMARY

Aspects of the present disclosure are directed toward a computer-implemented method comprising monitoring storage bandwidth designated for one or more storage operations in association with one or more storage volumes attached to a server that hosts containerized applications, where a fixed amount of bandwidth provided to the server is divided between the storage bandwidth available for the one or more storage operations and network bandwidth available for network operations. The computer-implemented method further comprising determining that increasing the storage bandwidth will improve performance of at least one of the one or more storage operations. The computer-implemented method further comprising identifying an amount of the network bandwidth as being available for reallocation to the storage bandwidth, and reallocating the amount of the network bandwidth to the storage bandwidth for use in performing the one or more storage operations.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 is a block diagram illustrating an example computing environment implementing bandwidth allocation in a container orchestration system, in accordance with some embodiments of the present disclosure.

FIG. 2 is a flow diagram that illustrates an example method for modifying a storage bandwidth in association with a storage volume read/write operation, in accordance with some embodiments of the present disclosure.

FIG. 3 is a flow diagram illustrating an example method for modifying a storage bandwidth in response to detecting a storage volume backup/restore operation, in accordance with some embodiments of the present disclosure.

FIG. 4 is a flow diagram illustrating an example method for monitoring utilization of network bandwidth after a reallocation of unutilized network bandwidth to storage bandwidth, in accordance with some embodiments of the present disclosure.

FIG. 5 is a flow diagram that illustrates an example method for bandwidth management by a container orchestration system, in accordance with some embodiments of the present disclosure.

FIG. 6 is a block diagram that illustrates an example computing environment in which aspects of the present disclosure can be implemented, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward bandwidth allocation in container orchestration systems, and more specifically to adjusting network bandwidth and storage bandwidth by a container orchestration system. While not limited to such applications, embodiments of the present disclosure may be better understood in light of the aforementioned context.

When provisioning a server (e.g., a virtual server instance (VSI) or virtual machine (VM)) in a computing service environment (e.g., a virtual private cloud), a fixed amount of bandwidth is allocated to the server. The fixed amount of bandwidth can be determined by an instance profile selected when provisioning the server. Both network and storage bandwidth requirements for the server are satisfied from the fixed amount of bandwidth allocated to the server. Namely, the fixed amount of bandwidth allocated to the server is divided for use by networking (network bandwidth) and storage volumes (storage bandwidth). As an illustrative example, 75% of the server's fixed bandwidth can be designated as network bandwidth, and 25% can be designated as storage bandwidth. Network bandwidth includes the traffic that flows over the server's network interfaces, while storage bandwidth includes the traffic to the server's attached storage volumes.

In the context of container orchestration systems (e.g., Kubernetes®), a server's network bandwidth and storage bandwidth are utilized by containerized applications hosted on the server (also referred to as a worker node). Because the bandwidth allocated to the server is static and does not change per the containerized application's requirements, typically, the allocated bandwidth is not fully utilized by the containerized applications. Moreover, because storage volume backup/restore operations utilize the server's storage bandwidth, containerized application read/write operations that utilize the server's storage bandwidth can be negatively impacted during performance of a storage volume backup/restore operation.

Advantageously, aspects of the present disclosure overcome the challenges described above by reallocating the server's unutilized network bandwidth to the server's storage bandwidth in order to improve performance of one or more storage operations. More specifically, aspects of the present disclosure monitor storage bandwidth designated for storage operations (e.g., read/write operations and/or backup/restore operations) in association with one or more storage volumes attached to a server that hosts containerized applications. Aspects of the present disclosure determine, based on the monitoring, that increasing the storage bandwidth will improve performance of one or more storage operations. In response, aspects of the present disclosure identify an amount of unutilized network bandwidth that is available for reallocation to the storage bandwidth and reallocates the unutilized network bandwidth to the storage bandwidth for use in performing the one or more of the storage operations. Adjusting the division of the server's fixed bandwidth to increase storage bandwidth (and correspondingly decrease network bandwidth) makes more storage bandwidth available for performing the one or more storage operations, which consequently improves performance of the one or more storage operations. That is, because the adjustment makes additional storage bandwidth available, a storage operation can be performed in a shorter amount of time as compared to not adjusting the division of the server's fixed bandwidth to increase the storage bandwidth. Moreover, increasing a server's storage bandwidth to improve performance of storage operations, as disclosed herein, is an improvement to the functioning of a computer.

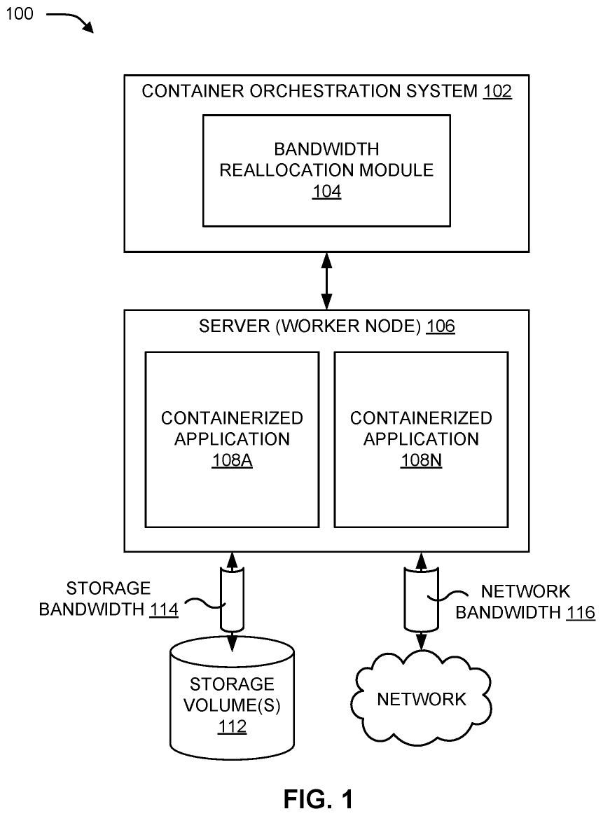

Referring now to the figures, FIG. 1 illustrates a block diagram of an example computing environment 100 that can implement bandwidth reallocation in a container orchestration system 102, in accordance with some embodiments of the present disclosure. As illustrated, the computing environment 100 can include a container orchestration system 102 that includes a bandwidth reallocation module 104.

Container orchestration automates the deployment, management, scaling, and networking of containerized applications 108A and 108N (collectively 108, where N can refer to any positive integer representing any number of containerized applications). Containers are a method of building, packaging, and deploying software as containerized applications 108. In the simplest terms, a containerized application 108 includes both application code and the dependencies that the application code needs to run properly. Multiple containerized applications 108 can execute on a same server 106 (e.g., a VSI or VM) and share an operating system (OS) kernel with other containerized applications 108, each executing as isolated processes in a user space. Containerized applications 108 offer many benefits, including portability between different computing environments. This makes containerized applications 108 easier to move between computing environments (e.g., cloud environments) without having to rewrite large amounts of computer code to ensure that the computer code will execute properly, regardless of the underlying operating system, or other factors. Container orchestration systems 102 manage the complexity associated with containerized applications 108. For example, a container orchestration system 102 can deploy containerized applications 108 across different computing environments without needing to redesign the application. The container orchestration system 102 manages worker nodes (server 106) that hosts containerized applications 108 and handles networking to ensure that network traffic between a containerized application 108 and a storage volume 112 is properly facilitated.

As shown in FIG. 1, the container orchestration system 102 includes the bandwidth reallocation module 104. The bandwidth reallocation module 104 monitors a server's fixed bandwidth, and in the event that the storage bandwidth 114 designated for storage operations is insufficient for performing a storage operation in relation to a storage volume 112 attached to the server 106, the bandwidth reallocation module 104 adjusts allocations of the server's fixed bandwidth to the storage bandwidth 114 based in part on the needs of the storage operation and the server's unutilized network bandwidth 116.

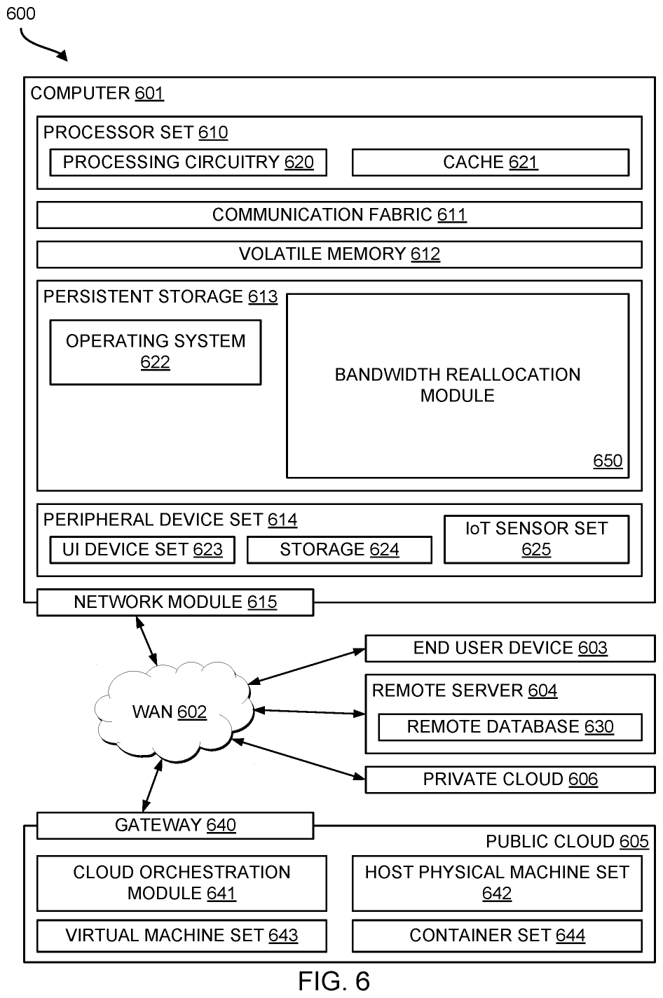

As described earlier, when a server 106 (worker node) is provisioned in a computing service environment (e.g., computing environment 600 of FIG. 6), a fixed amount of bandwidth is allocated to the server 106 for use by containerized applications 108 hosted on the server 106. The allocated amount of bandwidth (fixed bandwidth) is determined by a server profile (e.g., VSI profile) selected when provisioning the server 106, and the fixed bandwidth (stated in units of megabits per second (Mbps) or gigabits per second (Gbps)) is divided into network bandwidth 116 and storage bandwidth 114, such that network and storage bandwidth requirements for the server 106 are satisfied from the fixed bandwidth. As a non-limiting example, by default, a server's allocated bandwidth may be divided such that the network bandwidth 116 may be 75% of the server's allocated bandwidth, and the storage bandwidth 114 may be 25% of the server's allocated bandwidth.

Network bandwidth 116, in the context of the present disclosure, refers to an amount of a server's fixed bandwidth that is assigned exclusively for use by the server's network interfaces (e.g., virtual network cards attached to a VSI to facilitate network connectivity for the VSI). The network bandwidth 116 is set, implicitly, when a server 106 is created or as a result of a change in storage bandwidth 114. The network bandwidth 116 is shared by the server's attached network interfaces (not shown).

Storage bandwidth 114, in the context of the present disclosure, refers to an amount of a server's allocated bandwidth assigned exclusively for use with attached a storage volume(s) 112. The storage bandwidth 114 of the server 106 is utilized to the sum of read and write volume traffic.

In some embodiments, the bandwidth reallocation module 104 monitors a server's storage bandwidth 114 to determine whether the storage bandwidth 114 is sufficient to meet the needs of the storage operations that utilize the storage bandwidth 114. The storage operations can comprise Infrastructure as a Service (IaaS) level storage operations that read/write to storage volume(s) 112 attached to a server 106 and/or backup and restore the storage volume(s) 112. Generally, in response to detecting that a server's storage bandwidth 114 is insufficient for performing a storage operation (e.g., within a timeframe), the bandwidth reallocation module 104 determines whether the amount of needed storage bandwidth can be satisfied from unutilized network bandwidth 116 reallocated to the storage bandwidth 114, thereby increasing storage bandwidth 114 for performance of the storage operation. The method used to determine whether storage bandwidth 114 can be increased depends at least in part on the type of storage operation being performed, as described below.

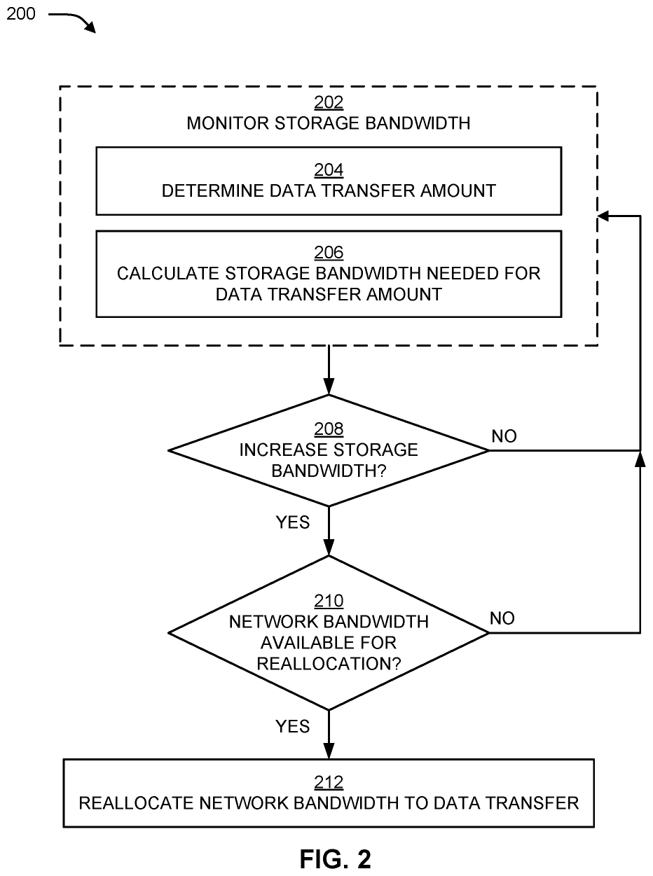

With continuing reference to FIG. 1, the flow diagram of FIG. 2 illustrates an example method 200 for modifying a server's storage bandwidth 114 in association with a storage operation that reads/writes to a storage volume 112. Starting in operation 202, the bandwidth reallocation module 104 monitors storage bandwidth 114 on a server 106 to detect conditions where the storage bandwidth 114 is fully utilized by one or more volume storage read/write operations, which may indicate a bottleneck condition where there is not enough data handling capacity to accommodate a current volume of storage related traffic. Monitoring the storage bandwidth 114 includes operation 204, which determines an amount of data (data transfer amount) being transferred by storage volume read/write operation(s), and operation 206, which calculates an amount of the storage bandwidth 114 needed to perform the storage volume read/write operation(s).

More specifically, in operation 204, the bandwidth reallocation module 104 determines an amount of data being transferred in association with current storage volume read/write operation(s) using data metrics associated with the storage volume read/write operation(s). The data metrics can include an application buffer size used by a containerized application 108 and a block size used by a file system of the storage volume 112 (typically, for performance reasons, the block size is set to match the application buffer size). The bandwidth reallocation module 104 can use the data metrics to calculate the amount of network traffic that is flowing to and from the server's storage volume(s) 112, and based on the amount, determine utilization of the server's storage bandwidth 114.

In operation 206, the bandwidth reallocation module 104 calculates how much storage bandwidth 114 is needed to transfer the data (the data transfer amount) associated with the storage volume read/write operation(s). For example, determining the needed storage bandwidth comprises calculating a throughput for performing the storage volume read/write operation(s) based on an input/output operations per second (IOPS) capability of the storage volume 112 and a block size of the data being stored/retrieved (throughput=storage volume IOPS*data block size). Illustratively, the IOPS for the storage volume 112 can be retrieved using a command line interface (CLI) provided by the container orchestration system 102, and the data block size can be based on how much data the storage volume read/write operation(s) is transferring at one time.

After determining the throughput for performing the storage volume read/write operation(s), the bandwidth reallocation module 104 compares the throughput with the current storage bandwidth (which can be obtained from a server profile), and if the throughput is greater than the current bandwidth, then in operation 208, the bandwidth reallocation module 104 makes a determination whether to increase the current storage bandwidth by reallocating unutilized network bandwidth 116 to the storage bandwidth 114.

In some embodiments, determining whether to reallocate network bandwidth 116 to storage bandwidth 114 includes a determination of whether the data associated with a read/write operation warrants the reallocation of the server's fixed bandwidth. For example, some data can be more important than other data, such that a delay in writing the data to a storage volume 112 and/or retrieving the data from the storage volume 112 can negatively impact other time sensitive operations (e.g., stock purchase orders, interest rate quotes, sport score reporting, etc.). Accordingly, the bandwidth reallocation module 104 analyzes the data associated with a read/write operation to determine whether the data is time-sensitive, and if the data is determined to be time-sensitive, the bandwidth reallocation module 104 continues with the method 200 to increase storage bandwidth 114 (if network bandwidth 116 is available). If the data is determined to not be time-sensitive, the bandwidth reallocation module 104 does not increase the server's storage bandwidth 114. In some embodiments, containerized applications 108 hosted on a server 106 can be classified based on an importance of the data that the containerized applications 108 handle. As a non-limiting example, the bandwidth reallocation module 104 can classify each containerized application 108 as time-sensitive or not-time-sensitive according to the type of data handled by the containerized applications 108. The bandwidth reallocation module 104 can then determine whether to increase the server's storage bandwidth 114 based in part on a classification of a containerized application 108.

In response to a decision to increase the server's storage bandwidth 114, in operation 210, the bandwidth reallocation module 104 determines whether unutilized network bandwidth 116 is available for reallocation to the storage bandwidth 114. In some embodiments, the bandwidth reallocation module 104 can use network metrics to calculate an amount of network traffic that is flowing to and from the server's network interface(s), and based on the amount, determine utilization of the server's network bandwidth 116. Based on the current utilization of network bandwidth 116, the bandwidth reallocation module 104 can determine whether there is an amount of the network bandwidth 116 that is unutilized. In the case that there is unutilized network bandwidth that can be reallocated to storage bandwidth 114, the bandwidth reallocation module 104 modifies the division of the server's allocated bandwidth to increase the server's storage bandwidth 114. Modifying the server's fixed bandwidth comprises changing the division of storage bandwidth 114 and network bandwidth 116 to a different percentage, such that increasing the storage bandwidth 114 decreases the network bandwidth 116.

In some embodiments, the bandwidth reallocation module 104 proactively reallocates network bandwidth 116 to storage bandwidth 114 based on a history of reads/writes of time-sensitive data. For example, historical reallocation data can be analyzed to identify times, conditions, etc. when to increase storage bandwidth 114 by decreasing network bandwidth 116, and based on the analysis, the bandwidth reallocation module 104 can proactively increase the storage bandwidth 114 during the identified times, conditions, etc. In some examples, a machine learning model can be trained to perform the analysis of the historical reallocation data and perform the proactive reallocation of the server's fixed bandwidth.

Also, in some embodiments, when (or after) provisioning a server 106 in a computing environment 100, the fixed bandwidth allocated to the server 106 can be divided between network bandwidth 116 and storage bandwidth 114 based on historical reallocations of network bandwidth 116 to storage bandwidth 114. For example, the bandwidth reallocation module 104 can analyze historical reallocation data to identify an average (or other value) amount of storage bandwidth 114 that has historically been used by containerized applications 108 hosted on a server 106, and the bandwidth reallocation module 104 can allocate (or reallocate) the server's fixed bandwidth to storage bandwidth 114 according to the average amount, and the remaining fixed bandwidth to network bandwidth 116. Setting an optimized storage bandwidth 114 and network bandwidth 116 on a server 106 based on the time sensitiveness of historical data can minimize context switching that too frequently reallocates the server's fixed bandwidth based on the changing needs on the server 106.

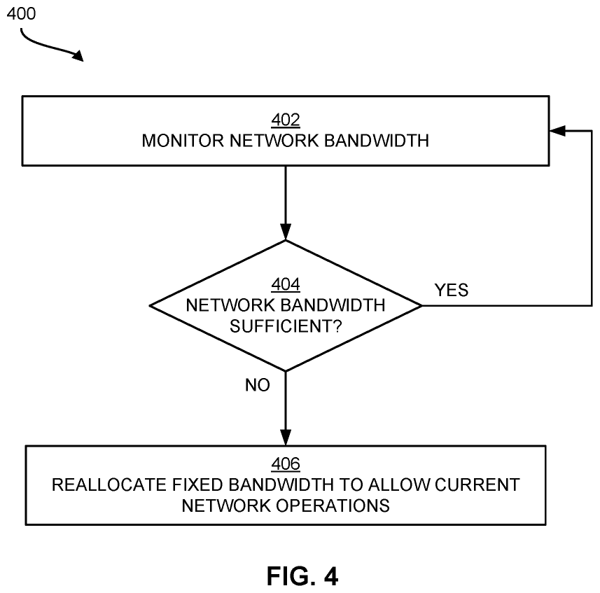

In some embodiments, after reallocating network bandwidth 116 to storage bandwidth 114 for use by a storage volume read/write operation(s), the bandwidth reallocation module 104 monitors usage of the network bandwidth 116 and reallocates the server's fixed bandwidth if needed, as described in more detail later in association with FIG. 4.

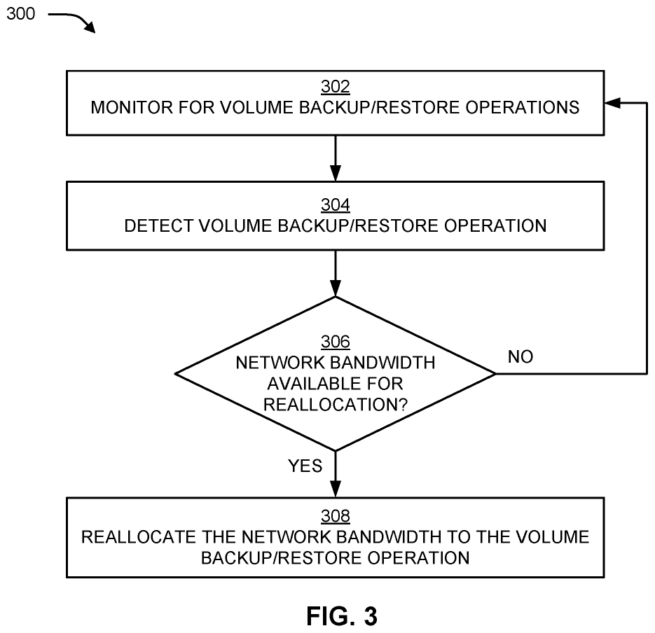

Now referring to FIG. 3 with continuing reference to FIG. 1. The flow diagram of FIG. 3 illustrates an example method 300 for modifying a server's storage bandwidth 114 in response to detecting a backup/restore operation invoked at an IaaS level. As background, volume backup/restore operations in a container orchestration system 102 create a point-in-time copy (e.g., snapshot) of a storage volume 112, and utilize the copy to restore (e.g., hydrate) the storage volume 112 to a previous state, or create a new volume from the copy. However, when a backup/restore operation of a server's storage volume 112 is performed, the server's storage bandwidth 114 is used, which decreases the amount of the server's storage bandwidth 114 and may negatively impact other storage operations on the server 106. For example, when the server's storage bandwidth 114 is too low, containerized applications 108 hosted on the server 106 may experience slow response times when accessing data on the server's storage volume(s) 112. The method 300 addresses this problem by increasing the server's storage bandwidth 114 using available network bandwidth 116 in response to detecting a backup/restore operation.

Starting in operation 302, the bandwidth reallocation module 104 monitors for volume backup/restore operations associated with one or more storage volumes 112 attached to a server 106. A backup operation can comprise a snapshot of a storage volume 112 attached to a server 106 utilized by one or more containerized applications 108, and a restore operation can comprise a hydration of the storage volume 112.

In operation 304, the bandwidth reallocation module 104 detects a volume backup/restore operation. Because the backup/restore operation utilizes the server's storage bandwidth 114, thereby reducing the amount of storage bandwidth 114 available to containerized applications 108 hosted on the server 106, the bandwidth reallocation module 104 determines whether to increase the server's storage bandwidth 114. As part of making this determination, in operation 306, the bandwidth reallocation module 104 identifies whether an amount of network bandwidth 116 is available for reallocation to storage bandwidth 114, which can be performed by determining a total network bandwidth being utilized by containerized applications 108 hosted on the server 106 (e.g., by obtaining network bandwidth utilization for each containerized application 108 and summing the network bandwidth utilization), and subtracting the total network bandwidth of the containerized applications 108 from the server's allocated network bandwidth 116.

In the case that there is unutilized network bandwidth that can be reallocated to storage bandwidth 114, the bandwidth reallocation module 104, in operation 308, reallocates the unutilized network bandwidth to the volume backup/restore operation. The reallocation modifies the division of the server's fixed bandwidth to increase the server's storage bandwidth 114 by the amount of the unutilized network bandwidth, and decrease the server's network bandwidth 116 by the amount of the unutilized network bandwidth.

Returning again to operation 304, in some embodiments, in response to detecting a volume backup/restore operation, the bandwidth reallocation module 104 first determines whether the backup/restore operation is negatively impacting the ability of the containerized applications 108 to perform read/write operations. In the case that the backup/restore operation is not negatively impacting the containerized applications 108, then no action is needed because the storage bandwidth 114 is sufficient for performing the backup/restore operation and the containerized application read/write operations. However, in the case that the backup/restore operation is negatively impacting the ability of the containerized applications 108 to perform volume read/write operations, then the bandwidth reallocation module 104, in operation 308, reallocates the unutilized network bandwidth to the volume backup/restore operation to increase storage bandwidth 114 by the amount of unutilized network bandwidth. In some embodiments, after reallocating network bandwidth 116 to storage bandwidth 114 in response to a backup/restore operation, the bandwidth reallocation module 104 monitors usage of the network bandwidth 116 on the server 106, and if needed, performs another reallocation of the server's fixed bandwidth to increase the network bandwidth 116, as described in association with FIG. 4 below.

In some embodiments, based on a history of backup/restore operations, the bandwidth reallocation module 104 can proactively increase storage bandwidth 114 (by correspondingly decreasing network bandwidth 116) in anticipation of a backup/restore operation. For example, historical backup/restore logs can be analyzed to identify times, conditions, etc. that correspond to backups and/or restorations of a storage volume 112, and based on the analysis, the bandwidth reallocation module 104 can proactively increase the storage bandwidth 114 (by decreasing network bandwidth 116) during the identified times, conditions, etc. In some examples, a machine learning model can be trained to perform the analysis of the historical backup/restore logs and perform the proactive reallocation of the server's fixed bandwidth.

Referring now to FIG. 4. with continuing reference to FIG. 1. The flow diagram of FIG. 4 illustrates a method 400 for monitoring utilization of network bandwidth 116 after a reallocation of unutilized network bandwidth to storage bandwidth 114. As described earlier, in response to the needs of storage bandwidth 114 on a server 106, an amount of unutilized network bandwidth 116 can be reallocated to storage bandwidth 114, which proportionally decreases the amount of network bandwidth 116 on the server 106. Should the need for network bandwidth 116 later increase on the server 106, the server's fixed bandwidth can again be reallocated to increase the network bandwidth 116.

Starting in operation 402, the bandwidth reallocation module 104 monitors network bandwidth 116 utilization on the server 106. For example, after a reallocation of unused network bandwidth to storage bandwidth 114, if the network bandwidth 116 is too low, the server 106 may experience slow response times when accessing external resources. Therefore, the bandwidth reallocation module 104 monitors utilization of the network bandwidth 116 to determine whether the network bandwidth 116 is sufficient for the needs of the containerized applications 108 hosted on the server 106.

In operation 404, based on the monitoring, the bandwidth reallocation module 104 determines whether the network bandwidth 116 is sufficient, and in the case that the containerized application's utilization of the network bandwidth 116 does not exceed the amount of network bandwidth allocated on the server 106, no action is taken. However, in the case that the network bandwidth 116 is too low, the bandwidth reallocation module 104 increases the network bandwidth 116 by modifying the division of the server's fixed bandwidth to increase the server's network bandwidth 116 and decrease the server's storage bandwidth 114 as shown in operation 406. In some embodiments, the division of network bandwidth 116 and storage bandwidth 114 is reset to a default setting (e.g., 75% network bandwidth 116 and 25% storage bandwidth). In some embodiments, the division of network bandwidth 116 and storage bandwidth 114 is determined based in part on a current and/or expected utilization of network bandwidth 116.

All or a portion of the computing environment 100 shown in FIG. 1 can be implemented, for example by all or a subset of the computing environment 600 of FIG. 6. Moreover, the bandwidth reallocation module 104 can be implemented in software, hardware, firmware or a combination thereof. When software is used, the operations performed by the bandwidth reallocation module 104 can be implemented in program instructions configured to run on hardware, such as a processor. When firmware is used, the operations performed by the bandwidth reallocation module 104 can be implemented in program instructions and data and stored in persistent memory to run on a processor. When hardware is employed, the hardware can include circuits that operate to perform the operations of the bandwidth reallocation module 104. A processor is a hardware device and is comprised of hardware circuits such as integrated circuits that respond to and process instructions and program instructions that operate a computer. Multiple processors located on the same computer or on different computers can be used to perform aspects of the present disclosure, and the aspects can be distributed between processors on the same or different computers. Illustratively, the processors can be selected from at least one of a single core processor, a dual-core processor, a multi-processor core, a general-purpose central processing unit (CPU), a graphics processing unit (GPU), a digital signal processor (DSP), or some other type of processor.

In some embodiments, the bandwidth reallocation module 104 can be implemented as a computing service hosted in the computing environment 100. For example, a module can be considered a service with one or more processes executing on a server or other computer hardware. Such services can provide a service application that receives requests and provides output to other services or consumer devices. An API can be provided for each module to enable a first module to send requests to and receive output from a second module. Such APIs can also allow third parties to interface with the module and make requests and receive output from the modules. While FIG. 1 illustrates an example of a computing environment that can implement the techniques above, many other similar or different environments are possible. For example, other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. The example environments discussed and illustrated above are merely representative and are not meant to be limiting.

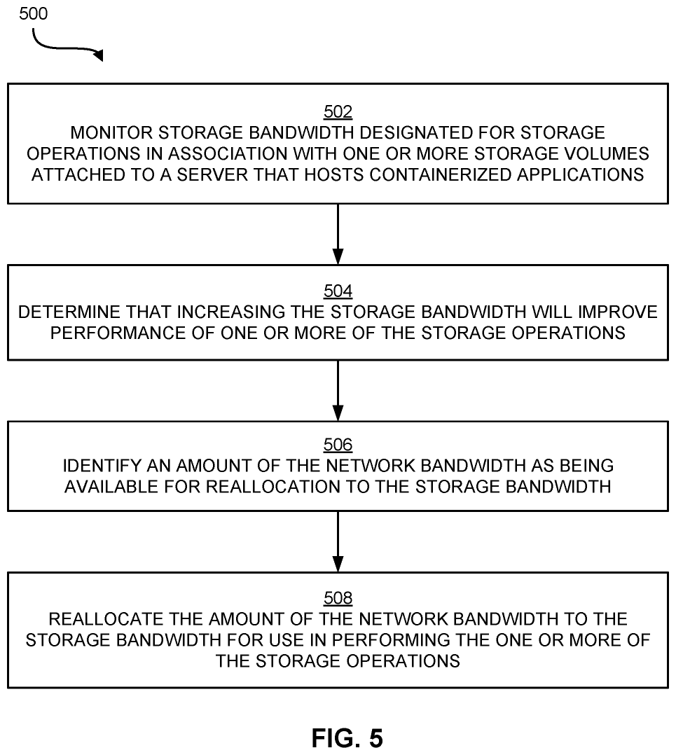

FIG. 5 is a flow diagram that illustrates an example method 500 for bandwidth management by a container orchestration system, in accordance with some embodiments of the present disclosure. In operation 502, the method 500 monitors storage bandwidth designated for storage operations in association with one or more storage volumes attached to a server that hosts containerized applications, where a fixed amount of bandwidth provided to the server is divided between the storage bandwidth available for the storage operations and network bandwidth available for network operations.

In operation 504, the method 500 determines that increasing the storage bandwidth will improve performance of one or more of the storage operations. In some embodiments, the one or more storage operations include one or more read/write operations invoked by one or more containerized applications, and determining that increasing the storage bandwidth will improve performance of at least one of the one or more storage operations includes calculating a throughput for performing the one or more read/write operations (e.g., calculating throughput for each of the one or more read/write operations based on a block size used by a containerized application and an input/output operations per second (IOPS) capability of a corresponding storage volume), and determining that the throughput is greater than the storage bandwidth available for performing the one or more read/write operations (indicating that the storage bandwidth is insufficient for performing the read/write operations). Also, in some embodiments, the one or more storage operations include a backup/restore operation of a storage volume that utilizes the storage bandwidth, and determining that increasing the storage bandwidth will improve performance of at least one of the one or more storage operations includes detecting that the backup/restore operation is being performed, and determining that the network bandwidth is not being fully utilized by the containerized applications, such that there is unutilized network bandwidth available. Moreover, in some embodiments, determining that increasing the storage bandwidth will improve performance of at least one of the one or more storage operations can be based on an analysis of a history of storage operations associated with the server that identifies times and/or conditions to increase the storage bandwidth.

In operation 506, the method 500 identifies an amount of the network bandwidth as being available for reallocation to the storage bandwidth, and in operation 508, the method 500 reallocates the amount of the network bandwidth to the storage bandwidth for use in performing the one or more of the storage operations. In some embodiments, the method 500 can further include monitoring the utilization of network bandwidth after a portion of the network bandwidth has been reallocated to storage bandwidth, and if a determination is made that the network bandwidth is insufficient for the server's current network operations, the method 500 reallocates the fixed amount of bandwidth provided to the server to allocate sufficient network bandwidth to the network operations.

In some embodiments, a history of bandwidth reallocations (logs) can be collected, and the history can be analyzed to determine a division of fixed bandwidth that reduces instances of reallocating amounts of network bandwidth to storage bandwidth. Thereafter, when provisioning a new server that corresponds to the history, the fixed bandwidth provisioned to the server can be divided between network bandwidth and storage bandwidth based on the analysis, such that instances of fixed bandwidth reallocation may be reduced.

The methods described above can be performed by a computer (e.g., computer 601 in FIG. 6), performed in a cloud environment (e.g., clouds 606 or 605 in FIG. 6), and/or generally can be implemented in fixed-functionality hardware, configurable logic, logic instructions, etc., or any combination thereof. Furthermore, the function or functions noted in the blocks may occur out of the order shown in FIG. 2, FIG. 3, FIG. 4, and FIG. 5. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the disclosed methods, such as block 650 containing computer code for the bandwidth reallocation module described earlier. In addition to block 650, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 650, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 621 and the other storage media discussed below. The computer readable program instructions, and associated data, are accessed by processor set 610 to control and direct performance of the disclosed methods. In computing environment 600, at least some of the instructions for performing the disclosed methods may be stored in block 650 in persistent storage 613.

COMMUNICATION FABRIC 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid-state storage devices. Operating system 622 may take several forms, such as various known proprietary operating systems or open-source Portable Operating System Interface type operating systems that employ a kernel. The code included in block 650 typically includes at least some of the computer code involved in performing the disclosed methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the disclosed methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. The terms “comprises,” “comprising,” “includes,” “including,” “has,” “having,” “contains” or “containing,” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. The term “user” refers to an entity (e.g., an individual(s), a computer, or an application executing on a computer). It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof.

In the example embodiments described herein, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, and to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

What is claimed is:

1. A computer-implemented method comprising:
monitoring storage bandwidth designated for one or more storage operations in association with one or more storage volumes attached to a server that hosts containerized applications,
wherein a fixed amount of bandwidth provided to the server is divided between the storage bandwidth available for the one or more storage operations and network bandwidth available for network operations;
determining that increasing the storage bandwidth will improve performance of at least one of the one or more storage operations;
identifying an amount of the network bandwidth as being available for reallocation to the storage bandwidth; and
reallocating the amount of the network bandwidth to the storage bandwidth for use in performing the one or more storage operations.

2. The computer-implemented method of claim 1, wherein the one or more storage operations include one or more read/write operations invoked by one or more containerized applications, and determining that increasing the storage bandwidth will improve performance of at least one of the one or more storage operations comprises:
calculating a throughput for performing the one or more read/write operations, wherein the throughput is calculated for each of the one or more read/write operations based on a block size used by a containerized application and an input/output operations per second (IOPS) capability of a corresponding storage volume; and
determining that the throughput is greater than the storage bandwidth available for performing the one or more read/write operations.

3. The computer-implemented method of claim 1, wherein the one or more storage operations include a backup/restore operation of a storage volume that utilizes the storage bandwidth, and determining that increasing the storage bandwidth will improve performance of at least one of the one or more storage operations comprises:
detecting performance of the backup/restore operation; and
determining that the network bandwidth is not being fully utilized by the containerized applications.

4. The computer-implemented method of claim 1, further comprising:
monitoring utilization of the network bandwidth;
determining that the network bandwidth is insufficient for the network operations; and
reallocating the fixed amount of bandwidth provided to the server to allocate sufficient network bandwidth to the network operations.

5. The computer-implemented method of claim 1, wherein determining that increasing the storage bandwidth will improve performance of at least one of the one or more storage operations further comprises:
analyzing a history of storage operations associated with the server to identify times and/or conditions to increase the storage bandwidth.

6. The computer-implemented method of claim 1, further comprising:
analyzing a history of bandwidth reallocation to determine a division of the fixed amount of bandwidth provided to the server that reduces instances of reallocating amounts of the network bandwidth to the storage bandwidth; and
dividing the fixed amount of bandwidth during provisioning of the server based on the analyzing.

7. The computer-implemented method of claim 1, wherein a container orchestration system manages reallocations of the network bandwidth to the storage bandwidth.

8. A system comprising:
one or more computer readable storage media storing program instructions and one or more processors which, in response to executing the program instructions, are configured to:
monitor storage bandwidth designated for one or more storage operations in association with one or more storage volumes attached to a server that hosts containerized applications,
wherein a fixed amount of bandwidth provided to the server is divided between the storage bandwidth available for the one or more storage operations and network bandwidth available for network operations;
determine that increasing the storage bandwidth will improve performance of at least one of the one or more storage operations;
identify an amount of the network bandwidth as being available for reallocation to the storage bandwidth; and
reallocate the amount of the network bandwidth to the storage bandwidth for use in performing the one or more storage operations.

9. The system of claim 8, wherein the one or more storage operations include one or more read/write operations invoked by one or more containerized applications, and the program instructions configured to cause the one or more processors to determine that increasing the storage bandwidth will improve performance of at least one of the one or more storage operations are further configured to cause the one or more processors to:
calculate a throughput for performing the one or more read/write operations, wherein the throughput is calculated for each of the one or more read/write operations based on a block size used by a containerized application and an input/output operations per second (IOPS) capability of a corresponding storage volume; and
determine that the throughput is greater than the storage bandwidth available for performing the one or more read/write operations.

10. The system of claim 8, wherein the one or more storage operations include a backup/restore operation of a storage volume that utilizes the storage bandwidth, and the program instructions configured to cause the one or more processors to determine that increasing the storage bandwidth will improve performance of at least one of the one or more storage operations are further configured to cause the one or more processors to:
detect performance of the backup/restore operation; and
determine that the network bandwidth is not being fully utilized by the containerized applications.

11. The system of claim 8, wherein the program instructions are further configured to cause the one or more processors to:
monitor utilization of the network bandwidth;
determine that the network bandwidth is insufficient for the network operations; and
reallocate the fixed amount of bandwidth provided to the server to allocate sufficient network bandwidth to the network operations.

12. The system of claim 8, wherein the program instructions configured to cause the one or more processors to determine that increasing the storage bandwidth will improve performance of at least one of the one or more storage operations are further configured to cause the one or more processors to:
analyze a history of storage operations associated with the server to identify times and/or conditions to increase the storage bandwidth.

13. The system of claim 8, wherein the program instructions are further configured to cause the one or more processors to:
analyze a history of storage bandwidth utilization to determine a division of the fixed amount of bandwidth provided to the server that reduces instances of reallocating amounts of the network bandwidth to the storage bandwidth; and
divide the fixed amount of bandwidth during provisioning of the server based on the analysis.

14. The system of claim 8, wherein a container orchestration system manages reallocations of the network bandwidth to the storage bandwidth.

15. A computer program product comprising:
one or more computer readable storage media, and program instructions collectively stored on the one or more computer readable storage media, the program instructions configured to cause one or more processors to:
monitor storage bandwidth designated for one or more storage operations in association with one or more storage volumes attached to a server that hosts containerized applications,
wherein a fixed amount of bandwidth provided to the server is divided between the storage bandwidth available for the one or more storage operations and network bandwidth available for network operations;
determine that increasing the storage bandwidth will improve performance of at least one of the one or more storage operations;
identify an amount of the network bandwidth as being available for reallocation to the storage bandwidth; and
reallocate the amount of the network bandwidth to the storage bandwidth for use in performing the one or more storage operations.

16. The computer program product of claim 15, wherein the one or more storage operations include one or more read/write operations invoked by one or more containerized applications, and the program instructions configured to cause the one or more processors to determine that increasing the storage bandwidth will improve performance of at least one of the one or more storage operations are further configured to cause the one or more processors to:
calculate a throughput for performing the one or more read/write operations, wherein the throughput is calculated for each of the one or more read/write operations based on a block size used by a containerized application and an input/output operations per second (IOPS) capability of a corresponding storage volume; and
determine that the throughput is greater than the storage bandwidth available for performing the one or more read/write operations.

17. The computer program product of claim 15, wherein the one or more storage operations include a backup/restore operation of a storage volume that utilizes the storage bandwidth, and the program instructions configured to cause the one or more processors to determine that increasing the storage bandwidth will improve performance of at least one of the one or more storage operations are further configured to cause the one or more processors to:
detect performance of the backup/restore operation; and
determine that the network bandwidth is not being fully utilized by the containerized applications.

18. The computer program product of claim 15, wherein the program instructions are further configured to cause the one or more processors to:
monitor utilization of the network bandwidth;
determine that the network bandwidth is insufficient for the network operations; and
reallocate the fixed amount of bandwidth provided to the server to allocate sufficient network bandwidth to the network operations.

19. The computer program product of claim 15, wherein the program instructions configured to cause the one or more processors to determine that increasing the storage bandwidth will improve performance of at least one of the one or more storage operations are further configured to cause the one or more processors to:
analyze a history of storage operations associated with the server to identify times and/or conditions to increase the storage bandwidth.

20. The computer program product of claim 15, wherein the program instructions are further configured to cause the one or more processors to:
analyze a history of storage bandwidth utilization to determine a division of the fixed amount of bandwidth provided to the server that reduces instances of reallocating amounts of the network bandwidth to the storage bandwidth; and
divide the fixed amount of bandwidth during provisioning of the server based on the analysis.
